(19) United States
(12) Patent Application Publication
(10) Pub. No.: US 2009/0037202 A1
(43) Pub. Date: Feb. 5, 2009

(54) Organization Maps and Mash-ups

(76) Inventors: Chandrasekhar Narayanaswami, Wilton, CT (US); Danny Soroker, Larchmont, NY (US)

Correspondence Address: F. CHAU & ASSOCIATES, LLC, 130 WOODBURY ROAD, WOODBURY, NY, 11797, US

(21) Appl. No.: 11/832,963

(22) Filed: Aug. 2, 2007

(51) Int. Cl. G06Q 10/00

(52) U.S. Cl. 705/1

(57) ABSTRACT

According to an embodiment of the present disclosure, a system for representing an organization as an organization map that can be manipulated and used as a substrate to plot data includes a memory storing data corresponding to the organization map and plot data, and a processor in communication with the memory for receiving organization map and the plot data and executing commands for rendering the organization map and the plot data including, rendering the organization map as a substrate, the organization map displaying a representation of individuals in the organization, and plotting the plot data on the organization map.

### BACKGROUND OF THE INVENTION

1. Technical Field

The present invention relates to organization maps and more particularly to a system and method for providing organization maps as a substrate for other technologies.

2. Description of Related Art

Technologies that allow composition of information from different sources have allowed the rapid development and deployment of mash-ups. The most common mash-ups include are based on geographic maps such as Google Maps, Yahoo Maps, etc. Having a programming interface for the geographic maps has allowed users to plot a variety of data on the maps. For example one could look up the location of cell towers listed in a cell tower database and plot symbols for those cell towers on a map. While printed maps have plotted artifacts on maps for several centuries and their digital analogs sold as packaged software have allowed users to filter and view several types of information, such systems have either been static (in the case of paper maps) or have not exposed programmable APIs through the web. Other examples of dynamic applications include tracking a parcel shipped via UPS, retrieving its current status and then plotting its location on a map.

Organization maps, often in the form of printed charts, are used to describe relationships between components of a business, for example, people, resources, partners, etc. The usefulness of organization maps are limited by the information contained therein. No known system or method exists for mapping information over an organization map.

Therefore, a need exists for a system and method for implementing an organization map as a substrate over which organization data can be rendered.

### SUMMARY OF THE INVENTION

According to an embodiment of the present disclosure, a system for representing an organization as an organization map that can be manipulated and used as a substrate to plot data includes a memory storing data corresponding to the organization map and plot data, and a processor in communication with the memory for receiving organization map and the plot data and executing commands for rendering the organization map and the plot data including, rendering the organization map as a substrate, the organization map displaying a representation of individuals in the organization, and plotting the plot data on the organization map.

According to an embodiment of the present disclosure, a computer readable medium is provided embodying instructions executable by a processor to perform a method for representing an organization as an organization map that can be manipulated and used as a substrate to plot data. The method includes receiving the organization map and the plot data, rendering the organization map, wherein the organization map is a connected hierarchical structure comprising a plurality of images representing elements in the organization and a plurality of interstitial frames between the plurality of images representing elements in the organization, and rendering the plot data on a rendering of the organization map.

### BRIEF DESCRIPTIONS OF THE DRAWINGS

Preferred embodiments of the present disclosure will be described below in more detail, with reference to the accompanying drawings:

FIG. 1 is an organization map substrate according to an embodiment of the present disclosure;

FIG. 2 is an organization map substrate including overlaid performance information according to an embodiment of the present disclosure;

FIG. 3 is an organization map substrate including overlaid programming skills information according to an embodiment of the present disclosure;

FIG. 4 is an organization map substrate including overlaid salary information according to an embodiment of the present disclosure;

FIG. 5 is an organization map substrate including overlaid aggregate dept salary information according to an embodiment of the present disclosure;

FIG. 6 is an organization map substrate including overlaid salary information with a privacy feature according to an embodiment of the present disclosure;

FIG. 7 is an organization map substrate including overlaid job information according to an embodiment of the present disclosure;

FIG. 8 is an organization map substrate including overlaid year-to-date travel expenses information according to an embodiment of the present disclosure;

FIG. 9 is an organization map substrate showing a zoom and pan feature according to an embodiment of the present disclosure;

FIG. 10 is an organization map substrate showing a zoom up feature according to an embodiment of the present disclosure;

FIG. 11 is a flow chart of a method for rendering an organization map according to an embodiment of the present disclosure; and

FIG. 12 is a diagram of a system for implementing an organization map substrate according to an embodiment of the present disclosure.

### DETAILED DESCRIPTION OF PREFERRED EMBODIMENTS

According to an embodiment of the present disclosure, an organizational map is implemented as a substrate for additional information. An organizational map is a representation of relationships in an organization, e.g., relationships between people, assets, resources, partners, etc. An organization map as a substrate allows for data to be plotted thereon.

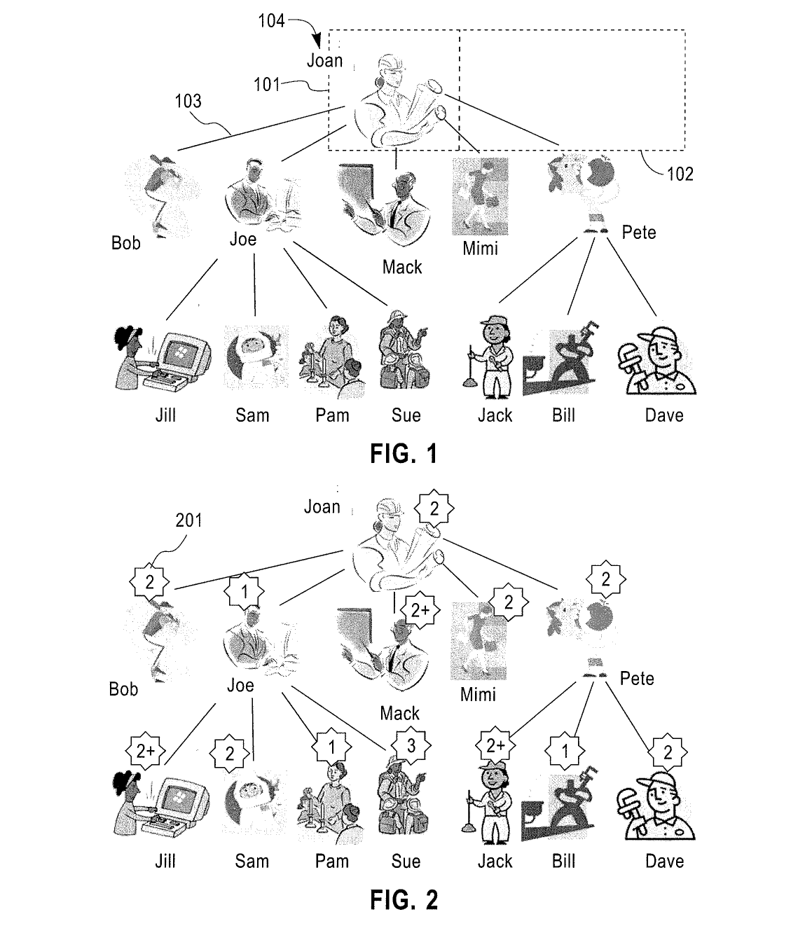

According to an exemplary embodiment of the present disclosure, an organizational map is a graphical representation of people in an organization (e.g., a business, government, community, etc.). Each person can be represented in the organization may, for example, by a picture or a graphic (see for example, FIG. 1). Two people in the same department will be proximal in the organizational map. An individual's supervisor will be shown above the group she manages and thus be close to the individual in the organization map. One of ordinary skill in the art would recognize the hierarchy may be organized having other orientations, e.g., left to right, bottom up, etc. The information is shown as an organizational hierarchy. If no hierarchy exists, one may be placed if needed. For example in a school students may be shown to report to teachers who in turn report to the administration, e.g., principal, superintendent, etc. Teachers of different sections in the same grade will be proximal in the organization.

To create the organizational map, images of elements of the organization, e.g., 101, such as photos of the individuals, may be stitched together to create an image canvas or substrate. Clip art may be used in place of photos. In other cases privacy issues may necessitate that substitute images be used instead of photos (for example, see FIG. 6, wherein the images are obscured by tiles 601). The photos will be resized as needed to make them consistent across the organization map. Interstitial tiles 102, such as a blank white-space tile, may be interleaved with the photos to improve the visual presentation of the organizational map. Organizational maps for parts of the organizations may be pre-computed and stored to improve rendering efficiency. They may be dynamically constructed in some cases to account for organizational changes that have not yet been reflected in the pre-computed organizational map. Further, the images may be connected by lines 103. The lines 103 may be attached to an edge or point on the images 101. In addition, the images may be associated with labels 104.

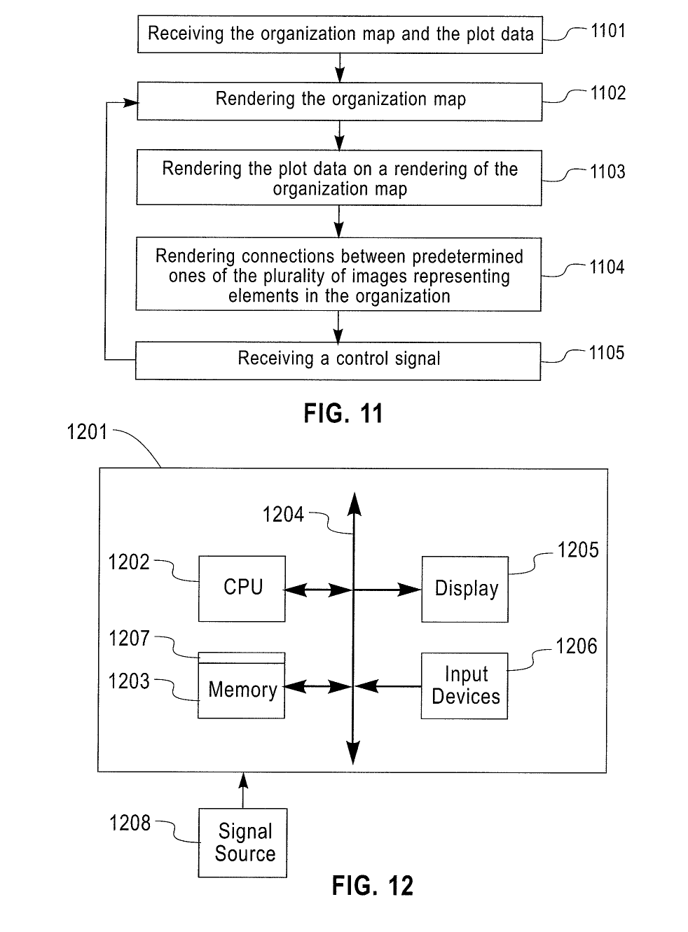

Referring to FIG. 11, a method for representing an organization as an organization map that can be manipulated and used as a substrate to plot data includes receiving the organization map and the plot data 1101, e.g., from a database, rendering the organization map 1102, which is implemented as a substrate for plot data. The database may be, for example, an institutional database, a web site, news feed, RSS feed, blog, podcast, catalog, etc. The organization map is a connected hierarchical structure (e.g., elements of the organization map are associated for tags, connecting lines, or the like) comprising a plurality of images representing elements in the organization and a plurality of interstitial frames between the plurality of images representing elements in the organization. The method further includes rendering the plot data on a rendering of the organization map 1103. The method further comprises rendering connections between predetermined ones of the plurality of images representing elements in the organization 1104.

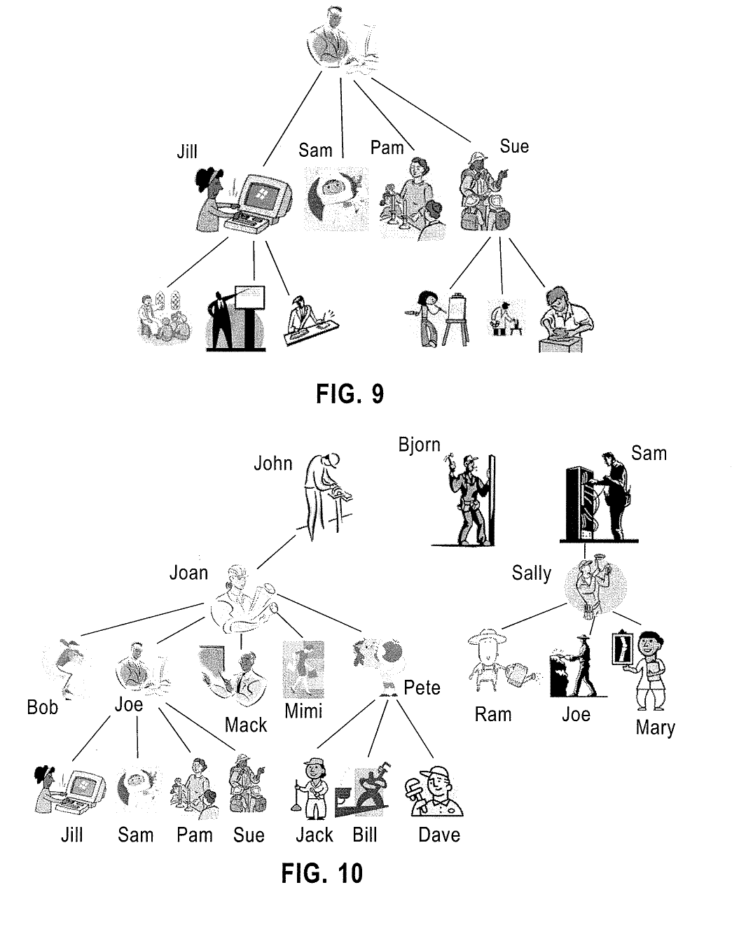

According to a control signal, e.g., received from an input device 1105, the organization map can be zoomed and panned (see for example, FIGS. 9 and 10). Panning the organizational map left or right may present parts of the organization that were not visible to the user earlier. Zooming in on an organizational map may cause it to reveal more detailed information about the part of the organization that is currently being viewed. The zooming and panning correct for holes in the planar representations for organizational map dues to the hierarchical nature of organizations, for example, by adding or removing interstitial tiles. Zooming in or out may include implementing another organizational map with visual features that are more suitable for a given level of zoom. For this reason multi-resolution representations of individual photos may be used. Organizational maps may be pre-computed at different levels and stored to facilitate rapid interaction.

Further, to increase a response speed of the organizational map to zoom and pan commands, portions of the organization map not currently displayed may be prefetched in anticipation, for example, adjacent portions outside of a display area and different levels of detail for different levels of zoom.

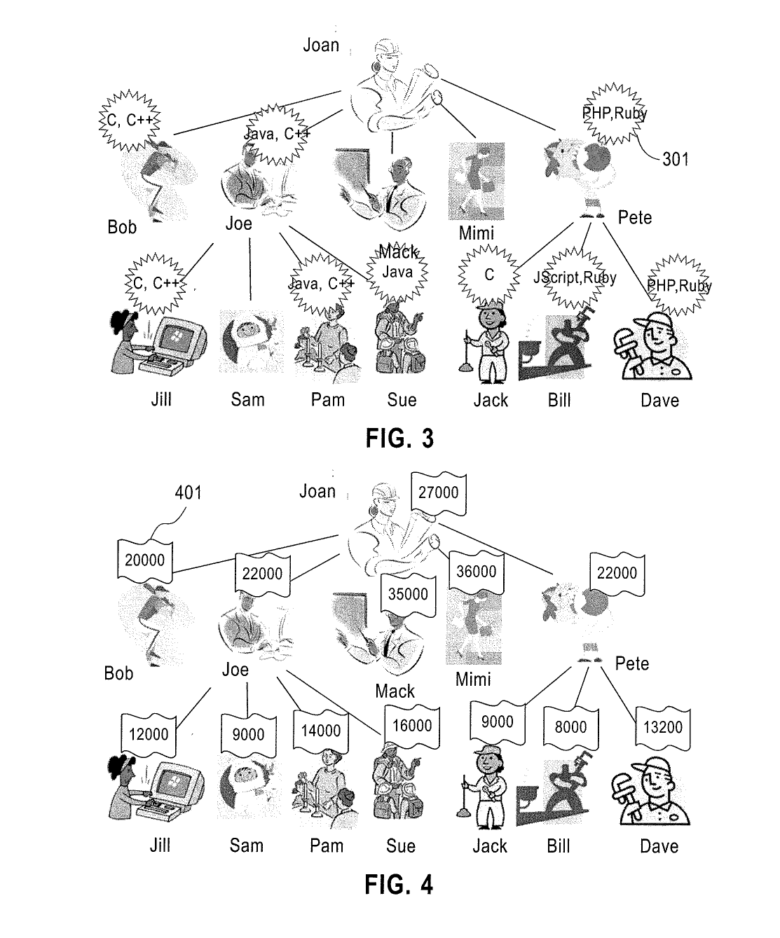

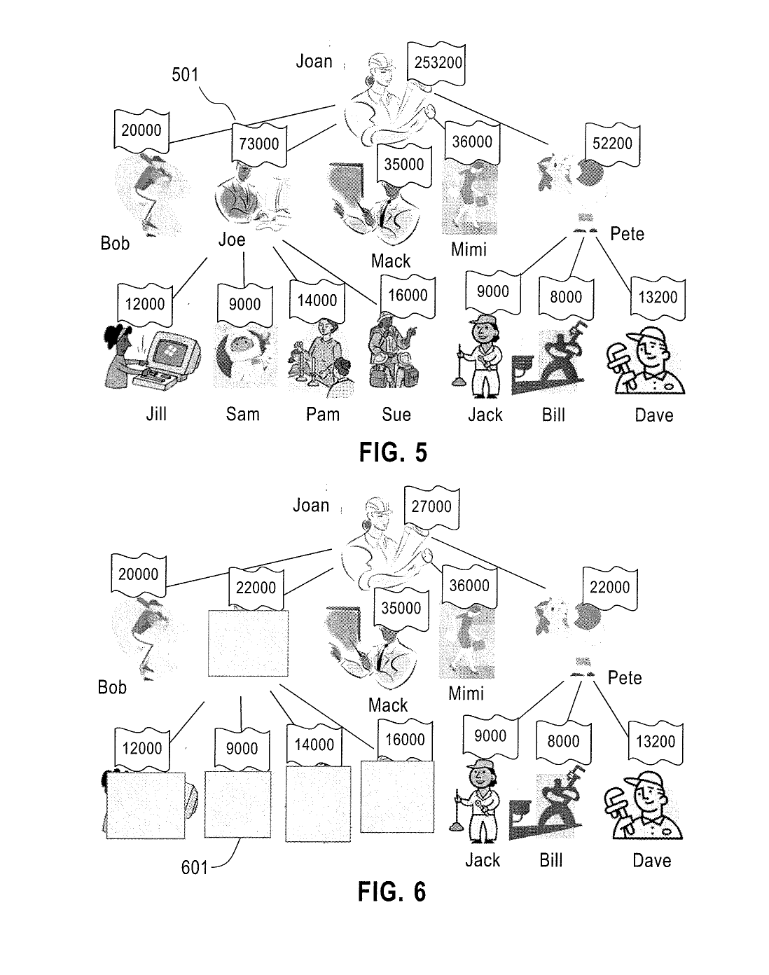

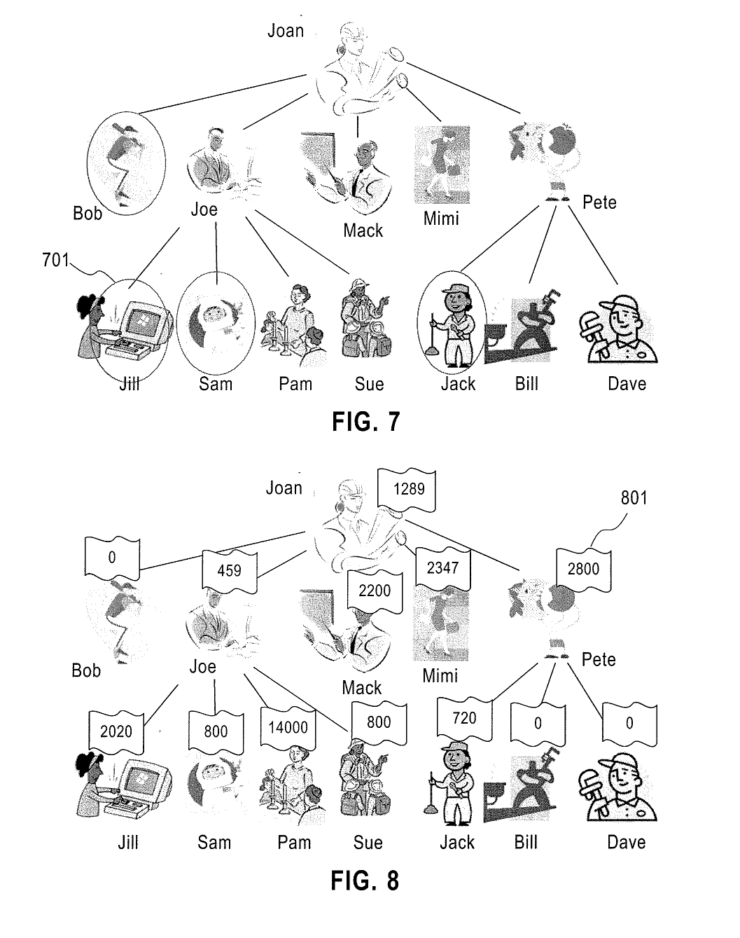

Additional data can be plotted on top of the organizational map, for example, connected to or associated with an image. For example, the data can include employee performance (e.g., 201, FIG. 2), salary (e.g., 401, FIG. 4), performance and salary history, skills (e.g., 301, FIG. 3), resources used by employee, such as amount of email storage used, number of emails received or sent, books purchased in calendar year, travel expenses to date (e.g., 801, FIG. 8) etc., employee feedback for managers, etc. FIG. 7 illustrate how a sub-set of elements may be accentuated using circles 701, for example, to show a group working on a shared project. Additional examples of data may include a number of patents or publications authored, recent classes taken, compliance status on organizational policies, etc. The data can be aggregated over a part of the organization and an aggregated data value can be shown at the root the aggregated organization tree (e.g., 501, FIG. 5). A zoom control signal, e.g., zoom-out, may also automatically cause the aggregation function to be executed. Zooming-in may reverse the aggregation and show additional details. For example, the overall travel expenses for a group can be added and shown on a higher level node or the average performance of sales departments may be plotted to identify poorly performing teams.

Data that is plotted on the organizational map can come from different sources. For example, the data may come from a human resources department, employee web pages, corporate directories, educational institutions, client and customers feedback databases, patent databases, publication catalogs, blogs, news feeds, professional associations, hospitals, insurance companies, etc.

Privacy preserving features such as blocking images 601 and data for individual employees or groups of employees may be provided. Overall access controls on data can substantially ensure that only people with appropriate access rights can create a mash-up between the plot data and the organizational map. Controls will also govern which pieces of data can be simultaneously be viewed by an individual. For example, in some cases the age and salary of an employee may not be viewed at the same time.

Facilities will be provided to update the organizational map efficiently to reflect changes in the organization. Certain nodes may be marked for lazy deletion to avoid excessive re-computation. Artifacts may be added to skip a deleted portion of the organizational map. For example if one employee reporting to a manager with 8 people leaves, the gap left by the person leaving could be replaced with a blank image and the space distributed evenly across the remaining 7 employees. At any point the map can be recomputed for compaction to avoid having holes.

A method is provided to translate between identity data, for example, an employee name, telephone number or other contact information, or department name or number or project name or identifier. Such data may be referenced in a search to find a part of the organization map proximal to a given element (e.g., an employee). This will allow a user to jump to the correct spot in the organizational map starting from a common method used to look up a person in corporate directories.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

Referring to FIG. 12, according to an embodiment of the present invention, a computer system 1201 implementing an organization map as a substrate can comprise, inter alia, a central processing unit (CPU) 1202, a memory 1203 and an input/output (I/O) interface 1204. The computer system 1201 is generally coupled through the I/O interface 1204 to a display 1205 and various input devices 1206 such as a mouse and keyboard. The support circuits can include circuits such as cache, power supplies, clock circuits, and a communications bus. The memory 1203 can include random access memory (RAM), read only memory (ROM), disk drive, tape drive, or a combination thereof. The present invention can be implemented as a routine 1207 that is stored in memory 1203 and executed by the CPU 1202 to process the signal from the signal source 1208. As such, the computer system 1201 is a general-purpose computer system that becomes a specific-purpose computer system when executing the routine 1207 of the present invention.

The computer platform 1201 also includes an operating system and micro instruction code. The various processes and functions described herein may either be part of the micro instruction code, or part of the application program (or a combination thereof) which is executed via the operating system. In addition, various other peripheral devices may be connected to the computer platform such as an additional data storage device and a printing device.

It is to be further understood that, because some of the constituent system components and methods depicted in the accompanying figures may be implemented in software, the actual connections between the system components (or the processes) may differ depending upon the manner in which the present invention is programmed. Given the teachings of the present invention provided herein, one of ordinary skill in the related art will be able to contemplate these and similar implementations or configurations of the present invention.

Having described embodiments for an organization map as a substrate, it is noted that modifications and variations can be made by persons skilled in the art in light of the above teachings. It is therefore to be understood that changes may be made in the particular embodiments of the invention disclosed which are within the scope and spirit of the disclosure.

What is claimed is:

1. A system for representing an organization as an organization map that can be manipulated and used as a substrate to plot data comprising:
a memory storing data corresponding to the organization map and plot data; and
a processor in communication with the memory for receiving organization map and the plot data and executing commands for rendering the organization map and the plot data comprising,
rendering the organization map as a substrate, the organization map displaying a representation of individuals in the organization; and
plotting the plot data on the organization map.

2. The system of claim 1, wherein the processor is responsive to a command received from an input device.

3. The system of claim 2, further comprising rendering a portion of the organizational map centered around a point in the organization map selected according to the command.

4. The system of claim 2, further comprising performing one or more of a panning operation and a zooming operation on a rendering of the organizational map according to the command.

5. The system of claim 2, further comprising plotting additional data on organization map according to the command.

6. The system of claim 1, wherein the organizational map is rendered from a plurality of visual representations having different resolutions.

7. The system of claim 6, wherein the organizational map is rendered at different levels of detail for different displayed layers of the organization.

8. The system of claim 1, further comprising computing placement of additional data on organizational map.

9. The system of claim 1, further comprising re-computing the organizational map upon a modification of the organization.

10. The system of claim 9, wherein the modification includes one of an individual entering the organization and an individual leaving the organization.

11. The system of claim 1, wherein the plot data pertains to aspects of the organization.

12. The system of claim 1, wherein the plot data corresponds to individuals rendered in the organization map.

13. The system of claim 1, wherein colors of portions of the organization map are altered to show data.

14. The system of claim 1, wherein a portion of the organization is omitted from the organization map.

15. The system of claim 1, wherein the command is a query executed against the data stored in the memory to render queried data.

16. The system of claim 1, wherein the processor prefetches data from the memory.

17. The system of claim 1, wherein a rendering of the organization map is hierarchical.

18. A computer readable medium embodying instructions executable by a processor to perform a method for representing an organization as an organization map that can be manipulated and used as a substrate to plot data, the method steps comprising:
receiving the organization map and the plot data;
rendering the organization map, wherein the organization map is a connected hierarchical structure comprising a plurality of images representing elements in the organization and a plurality of interstitial frames between the plurality of images representing elements in the organization; and
rendering the plot data on a rendering of the organization map.

19. The computer readable medium of claim 18, wherein the method further comprises rendering a connection between predetermined ones of the plurality of images representing elements in the organization.

20. The computer readable medium of claim 18, wherein the method further comprises modifying the rendering of the organizational map according to a command signal.
